(19) United States
(12) Patent Application Publication
(10) Pub. No.: US 2006/0268375 A1
(43) Pub. Date: Nov. 30, 2006

(54) Recording apparatus for sorting recording media having recorded image data thereon and method of sorting the recording media

(75) Inventor: Noriaki Seto, Kawasaki-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/438,433

(22) Filed: May 23, 2006

(30) Foreign Application Priority Data
May 27, 2005 (JP) 2005-155040

(51) Int. Cl. G06F 3/12

(52) U.S. Cl. 358/498; 358/1.1

(57) ABSTRACT

It is an object of the invention to provide a recording apparatus in which the user photographs one scene of an entertainment or an event such as group tour, field day, or the like by a digital camera. Image data of the photographed images is stored into a memory card. When the user prints the image data from the memory card and distributes photo images to many persons, a burden of the operation to sort the photographs can be lightened without wastefully consuming the time. For this purpose, the user selects any one of the images stored in the memory card, inputs the number of prints of the selected image, and instructs the printing. Thereafter, the recording apparatus executes processes for setting a recording medium on which the last page of each print job has been recorded to a divider page of the print jobs in order of the instructed print jobs, reversing the recording medium to the back side, and discharging the medium.

### BACKGROUND OF THE INVENTION

1. Field of the Invention

The invention relates to a recording apparatus which has a card slot and in which image data stored in a memory card can be directly read out. In the apparatus, a print instruction is made by selecting a desired one of images stored in the memory card and inputting the number of prints of the selected image by means of operation means, and recording means prints the image on the basis of the print instruction.

2. Related Background Art

In recent years, digital cameras each for storing photo images as digital data into a memory card have widely been spread. At the beginning, since an apparatus capable of handling the digital image data was only a personal computer, in order to print the photo images, the photo image data is stored into the personal computer or the memory card in which the photo images have been stored is connected to the personal computer, the digital image data is read out, the photo image data is transferred to a recording apparatus from the personal computer, and the photo images are printed.

However, the users who have the digital cameras but do not have the personal computers have also appeared and there are recording apparatuses in which images photographed by the digital camera can be easily printed without using a host computer.

As one of such recording apparatuses, there has been known an apparatus which has a card slot to connect a memory card in which image data has been stored to the recording apparatus and has a photo printing function of directly reading out the image data stored in the memory card and printing the images (for example, refer to Japanese Patent Application Laid-open No. 2000-118081).

To meet various demands of the users, the photo printing function provides various printing functions. Specifically speaking, there are the following functions: an index printing function of performing a list printing of all of the image data stored in the memory card; a function of selecting a plurality of images by one print instructing operation, inputting the number of prints with respect to each image, and collectively printing the plurality of images to be printed; a DPOF (Digital Print Order Format) printing in accordance with DPOF settings set by the digital camera; and the like.

A camera using method which is common is a using method whereby one scene of an entertainment or an event such as group tour, field day, or the like is recorded on a photograph and additional copies of the photograph are made and distributed to many participants in the entertainment or the event. Demands for the type and the number of photographs to be distributed differ in dependence on the participants in the entertainment or the event who want to get the distribution of the photographs.

In the foregoing recording apparatus having the photo printing function, in the case of printing the photo images in the above situation, either one of the following methods is used: a method whereby the operation for designating an image to be distributed to one predetermined person, designating the number of prints of the image and printing is repeated the number of times corresponding to the number of people; and a method whereby an image to be distributed to each person is designated with respect to each of all people, the number of prints is checked, the numbers of prints are summed with respect to the respective images, the printing of the necessary number of prints for all of the people is instructed by one operation, and they are collectively printed.

Each of the above two methods of printing and distributing the photo images to a plurality of people by using the recording apparatus having the photo printing function has the following problem.

According to the conventional method whereby the operation for designating the image to be distributed to one predetermined person and the number of prints of the image and printing is repeated the number of times corresponding to the number of people, there is such a problem that since the operator is substantially restricted to the operation of the apparatus until completion of the print jobs of all of the people, the time is wastefully consumed.

According to the conventional method whereby the number of prints of each of the images to be distributed to each person is checked, the numbers of prints to be printed are summed with respect to the respective images, the printing of all of the images to be distributed to all of the people is instructed by one operation, and they are collectively printed, although the operator is not restricted to the operation of the apparatus, there is such a problem that a burden of the operation to sort the photographs to be distributed to each person after completion of the print jobs of all of the people is heavy.

### SUMMARY OF THE INVENTION

It is an object of the invention to provide a recording apparatus in which one scene of an entertainment or an event such as group tour, field day, or the like is photographed by a digital camera, image data of the photographed images is stored into a memory card, the image data is read out of the memory card, photo images are printed, and when additional copies of the photograph are made and distributed to many participants in the entertainment or the event, a burden of the operation to sort the photographs to be distributed to each person can be lightened without wastefully consuming the time.

According to an embodiment of the invention, there is provided a recording apparatus comprising: storing means adapted to store image data; operation means adapted to select image(s) stored in the storing means and input the number of prints of the selected image on a job unit basis; recording means adapted to record the image onto a recording medium on the job unit basis; and reversing means adapted to reverse the recording medium on which a predetermined page of each job has been recorded as a divider of each job when the image is continuously recorded on the job unit basis by the recording means after completion of the inputting operation by the operation means.

According to another embodiment of the invention, there is provided a control method in a recording apparatus for recording image data stored in a storing unit onto a recording medium, comprising: an input operating step of selecting image(s) stored in the storing unit and inputting the number of prints of the selected image on a job unit basis; a recording step of recording the image onto the recording medium on the job unit basis; and a reversing step of reversing the recording medium on which a predetermined page of each job has been recorded as a divider of each job when the image is continuously recorded on the job unit basis in the recording step after completion of the inputting operation by the operating step.

### BRIEF DESCRIPTION OF THE DRAWINGS

FIG. 1 is a block diagram showing a recording apparatus 100 according to a first embodiment of the invention;

FIG. 2 is a flowchart showing the control operation of the recording apparatus 100 and is the flowchart showing the control operation in the first embodiment of the invention;

FIG. 3 is a flowchart showing the control operation in a second embodiment of the invention;

FIG. 4 is a flowchart showing the control operation in a third embodiment of the invention;

FIG. 5 is a flowchart showing the control operation in a fourth embodiment of the invention;

FIG. 6 is a flowchart showing the control operation in a fifth embodiment of the invention; and

FIG. 7 is a flowchart showing the control operation in a sixth embodiment of the invention.

### DETAILED DESCRIPTION OF THE PREFERRED EMBODIMENTS

The best mode for carrying out the invention is the following embodiments.

### First Embodiment

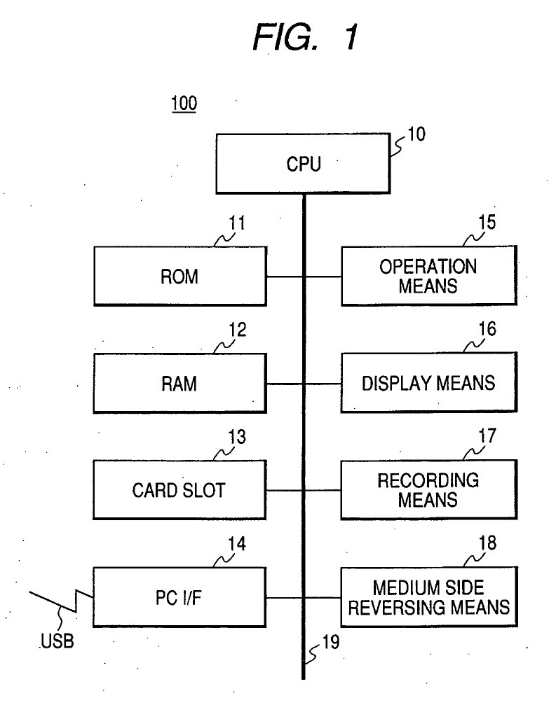

FIG. 1 is a block diagram showing a recording apparatus 100 according to a first embodiment of the invention.

The recording apparatus 100 has: a CPU 10; a ROM 11; a RAM 12; a card slot 13; PC interface means (hereinafter, simply referred to as a PC I/F) 14; operation means 15; display means 16; recording means 17; recording medium front/back side reversing means (hereinafter, simply referred to as medium side reversing means) 18; and a bus 19.

The CPU 10 controls the recording apparatus 100 in accordance with various programs. Various control programs for the recording apparatus 100 have been stored in the ROM 11.

The RAM 12 is storing means for executing the reading of the various control programs in the ROM 11, storage of various setting information of the apparatus, storage of print data formed so as to be transferred as data for printing to the recording means on the basis of image data stored in a memory card, and the like. Paper feeding port mounted recording medium type storing means for registering a type of recording media mounted in each paper feeding port is also an example of the RAM 12.

The card slot 13 is provided for connecting the memory card in which the image data has been stored and directly reading out the image data therefrom. The PC I/F 14 is used to communicate with a host computer through a USB cable and transmit and receive various kinds of data including the image data.

The operation means 15 is means for changing the various setting information of the recording apparatus 100 and inputting a print job in the photo print. The operation means 15 is also used when the user manually switches the paper feeding port to be selected. The display means 16 is means for notifying the user of various modes of the recording apparatus 100.

The recording means 17 is means for printing an image onto the recording medium on the basis of the transferred image data in accordance with the print job instructed by the host computer or the operation means 15. The medium side reversing means 18 is provided for reversing the recording medium to the back side in order to discharge the recording medium in the front/back reversed state or to form images onto both of the front/back sides of the recording medium. The bus 19 is used to mutually connect various kinds of hardware including the CPU.

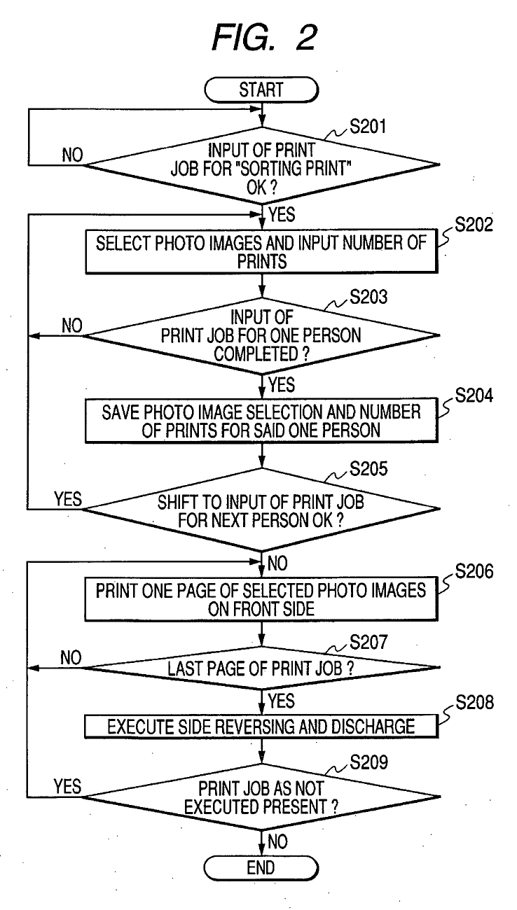

FIG. 2 is a flowchart showing the control operation of the recording apparatus 100 and is the flowchart showing the control operation in the first embodiment of the invention.

The first embodiment relates to an example in which the recording medium on which the last page of each print job has been printed is reversed to the back side and the medium is discharged in the reversed state. In the example, the last page of each print job is set to a divider page of the print job and the recording medium is discharged in the state where the front/back sides have been reversed. Thus, the user can easily discriminate the dividers of a plurality of print jobs.

First, in order to distribute recorded media, after the operation to select the images on a sorting unit basis and the operation to input the print jobs of the number of prints were continuously executed, whether or not a print job input to use a function of continuously executing the printing operation in order of the instructed print jobs (hereinafter, referred to as “sorting print”) is started is discriminated (step S201).

If the start of the print job input of “sorting print” mentioned above is instructed, first, the photo images to be distributed to the people are selected and the number of prints of each of the selected images is inputted (S202). Whether or not the input of the print job to be distributed to one person has been completed is discriminated (S203).

If the print job input is not completed, the print job input in S202 is continued. However, if the print job input has been completed, the print job to be distributed to one person is stored into the RAM 12 (S204).

Subsequently, whether or not the processing routine is shifted to the input of the print job to be distributed to the next people is discriminated (S205). If the processing routine is shifted to the print job input to be distributed to the next person, the processing routine is returned to S202 and the operation to input the print job to be distributed to the next person is executed.

If it is determined in S205 that the processing routine is not shifted to the print job input to be distributed to the next person, it is regarded that all of the print job inputs to be distributed to all of the people have been completed, so that the selected photo image is printed by one page onto the front side of the recording medium on the basis of the print job input (S206).

Subsequently, whether or not the page printed in S206 is the last page of the print job is discriminated (S207). If the printed page is not the last page of the print job, the recording medium on the front side of which the selected photo image has been printed is discharged. The processing routine is returned to S206 and the selected photo image of the next page is printed.

If the printed page is the last page of the print job, in order to set such a page to a divider page of the print job, the recording medium on the front side of which the selected photo image has been printed is reversed to the back side by the medium side reversing means 18 and the reversed medium is discharged (S208).

Subsequently, the presence or absence of the print job which is not executed yet is discriminated (S209). If the print job which is not executed yet is found, the processing routine is returned to S206 and the selected photo image is printed by one page onto the front side of the recording medium. If the print job which is not executed yet is not found in S209, in other words, if all of the print jobs to be distributed to all of the people have been completed, the processing routine is finished.

If there is no print job input of “sorting print” in S201, the recording medium is discharged without executing the reversing process. That is, if there is an instruction of “sorting print”, the medium side reversing means 18 can be validated.

### Second Embodiment

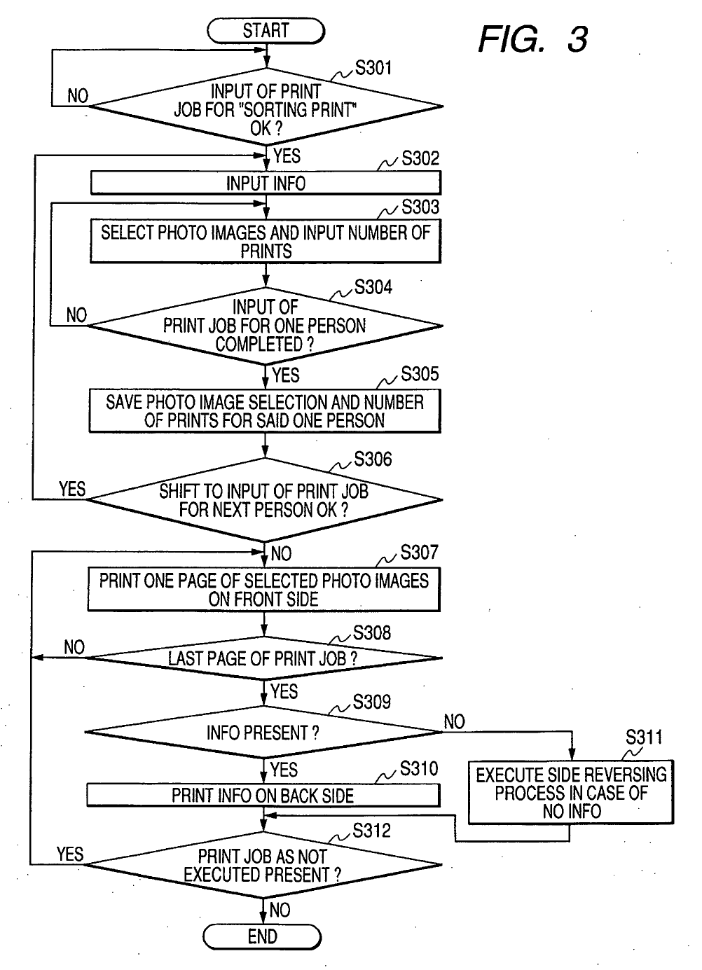

FIG. 3 is a flowchart showing the control operation in the second embodiment of the invention.

A construction in the second embodiment is similar to that of the recording apparatus 100 shown in FIG. 1.

The second embodiment relates to an example in which information showing the people to be distributed of the recorded media is printed as a divider page of the print job onto the back side of the last page. By this construction, the user can easily discriminate not only the dividers of a plurality of print jobs but also the people.

First, whether or not the print job input to use “sorting print” is started is discriminated (S301). If the start of the print job input for “sorting print” is instructed, first, information (for example, the names of the people, etc.) indicative of the people to which the recorded media is distributed is inputted (S302). The photo images to be distributed to the people are selected and the number of prints of each of the selected images is inputted (S303). Whether or not the print job input to be distributed to one person has been completed is discriminated (S304).

If the print job input is not completed, the print job input in S303 is continued. If the print job input has been completed, the print job to be distributed to one person is stored into the RAM 12 (S305). Whether or not the processing routine is shifted to the print job input to be distributed to the next person is discriminated (S306). If the processing routine is shifted to the print job input to be distributed to the next person, the processing routine is returned to S302 and, the information indicative of the people to which the recorded media is distributed next is inputted. The operation for the print job input of the recorded media to be distributed to the person is executed in S303. If it is determined in S306 that the processing routine is not shifted to the print job input to be distributed to the next person, it is regarded that all of the print job inputs to be distributed to all of the people have been completed. The selected photo image is printed by one page onto the front side of the recording medium on the basis of the print job input (S307).

Subsequently, whether or not the page printed in S307 is the last page of the print job is discriminated (S308). If the printed page is not the last page of the print job, the recording medium on the front side of which the selected photo image has been printed is discharged. The processing routine is returned to S307 and the selected photo image of the next page is printed. If the printed page is the last page of the print job, the process to set such a page to a divider page of the print job is executed. The presence or absence of the information inputted in S302 is discriminated (S309). If the information exists, the medium side reversing means 18 reverses the recording medium on the front side of which the selected photo image has been printed to the back side and the information is printed onto the back side (S310).

If the information does not exist, a back-side process (the medium is reversed and discharged in the back-side-up state; a divider mark is printed onto the back side; a print job serial number is printed onto the back side; or the like) in the case of the absence of the information indicative of person to be distributed is executed (S311). The presence or absence of the print job which is not executed yet is discriminated (S312). If the print job which is not executed yet is found, the processing routine is returned to S307 and the selected photo image is printed by one page onto the front side of the recording medium. If the print job which is not executed yet is not found in S312 (in other words, if all of the print jobs to be distributed to all of the people have been completed), the processing routine is finished.

### Third Embodiment

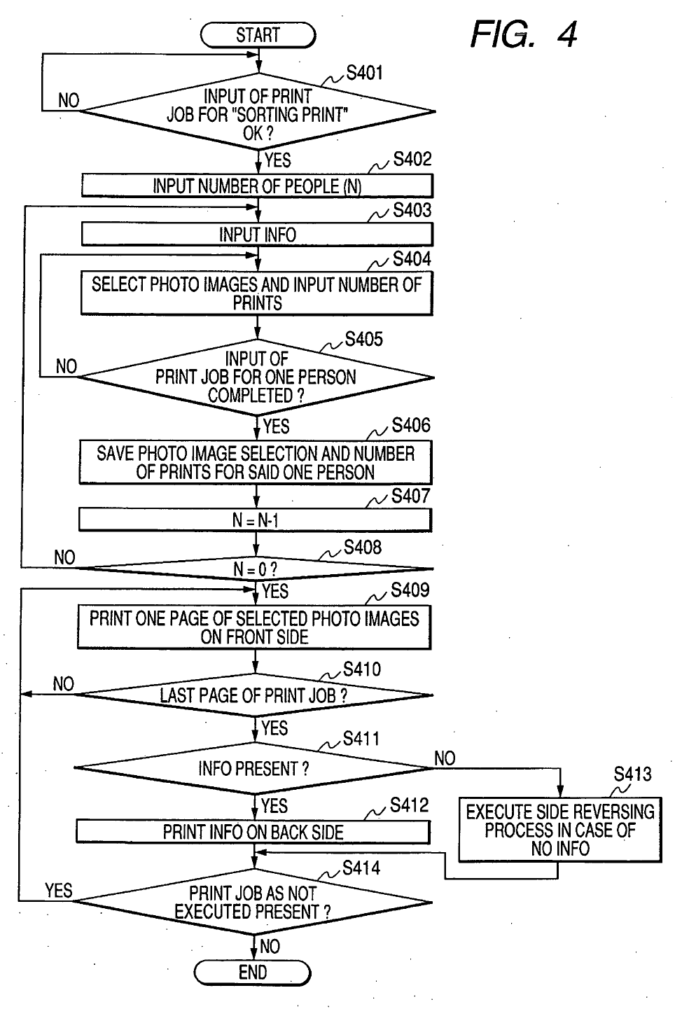

FIG. 4 is a flowchart showing the control operation in the third embodiment of the invention.

A construction in the third embodiment is similar to that of the recording apparatus 100 shown in FIG. 1.

The third embodiment relates to an example in which before the print job is inputted, a sorting number which is used to sort the recorded media is preliminarily inputted, and the information showing the person to be distributed is printed as a divider page of the print job onto the back side of the last page. By this construction, for example, if the sorting number is assumed to be the number of people, the selection of the photo images as many as the number of people and the input of the number of prints can be automatically repeated.

First, whether or not the print job input to use “sorting print” is started is discriminated (S401). If the start of the print job input for “sorting print” is instructed here, the number of people to which the recorded media is distributed is inputted to a print job input number counter N (S402).

Subsequently, the information indicative of the people to which the recorded media is distributed is inputted (S403). The photo images to be distributed to the people are selected and the number of prints of each of the selected images is inputted (S404). Whether or not the print job input to be distributed to one person has been completed is discriminated (S405). If the print job input is not completed, the print job input in S404 is continued. If the print job input has been completed, the print job to be distributed to one person is stored into the RAM 12 (S406).

Subsequently, “1” is subtracted from the value of the print job input number counter N (S407). Whether or not the value of the print job input number counter N is equal to 0 is discriminated (S408). If it is not equal to 0, the processing routine is returned to S403 and the information indicative of the people to which the recorded media is distributed is inputted. The operation for the print job input to be distributed to the person is executed in S404. If the value of the counter N is equal to 0 in S408, it is regarded that all of the print job inputs to be distributed to all of the people have been completed. The selected photo image is printed by one page onto the front side of the recording medium on the basis of the print job input (S409).

Subsequently, whether or not the page printed in S409 is the last page of the print job is discriminated (S410). If the printed page is not the last page of the print job, the recording medium on the front side of which the selected photo image has been printed is discharged. The processing routine is returned to S409 and the selected photo image of the next page is printed. If the printed page is the last page of the print job, the process to set such a page to the divider page of the print job is executed.

First, the presence or absence of the information indicative of the person inputted in S403 is discriminated (S411). If the information exists, the recording medium on the front side of which the selected photo image has been printed is reversed to the back side by the medium side reversing means 18 and the information is printed on the back side (S412). If the information does not exist, the back-side process (the medium is reversed and discharged in the back-side-up state; the divider mark is printed onto the back side; the print job serial number is printed onto the back side; or the like) in the case of the absence of the information indicative of the people is executed (S413).

The presence or absence of the print job which is not executed yet is discriminated (S414). If the print job which is not executed yet is found, the processing routine is returned to S409 and the selected photo image is printed by one page onto the front side of the recording medium. If the print job which is not executed yet is not found in S414 (in other words, if all of the print jobs to be distributed to all of the people have been completed), the processing routine is finished.

### Fourth Embodiment

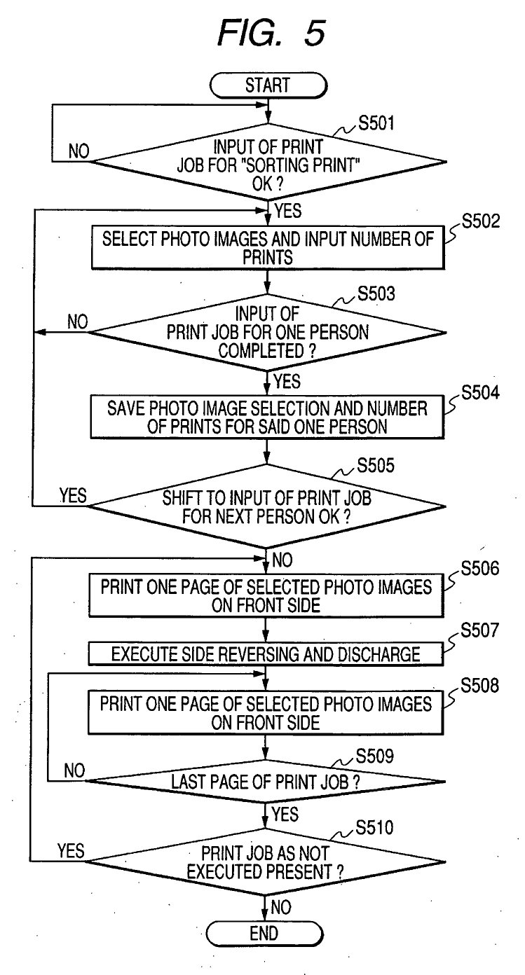

FIG. 5 is a flowchart showing the control operation in the fourth embodiment of the invention.

A construction in the fourth embodiment is similar to that of the recording apparatus 100 shown in FIG. 1.

The fourth embodiment relates to an example in which the head page of each print job is set to the divider page of the print job, the recording medium is reversed to the back side, and the medium is discharged.

Since processes in S501 to S505 are substantially the same as those in S201 to S205 in FIG. 2, their explanation is omitted here.

If the processing routine is not shifted to the print job input to be distributed to the next person in S505 but the print job inputs to be distributed to all of the people have been completed, the selected photo image is printed by one page onto the front side of the recording medium (S506). In order to set the head page of the print job to the divider page of the print job, the recording medium on the front side of which the selected photo image has been printed is reversed to the back side by the medium side reversing means 18 and the reversed medium is discharged (S507).

Subsequently, in order to print the second and subsequent pages of the print job, the selected photo image is printed by one page onto the front side of the recording medium (S508). Whether or not the page printed in S508 is the last page of the print job is discriminated (S509). If the printed page is not the last page of the print job, the recording medium on the front side of which the selected photo image has been printed is discharged. The processing routine is returned to S508 and the selected photo image of the next page is printed.

If the printed page is the last page of the print job, the presence or absence of the print job which is not executed yet is discriminated (S510). If the print job which is not executed yet is found, the processing routine is returned to S506 and the selected photo image is printed by one page onto the front side of the recording medium. If the print job which is not executed yet is not found in S510 (in other words, if all of the print jobs to be distributed to all of the people have been completed), the processing routine is finished.

### Fifth Embodiment

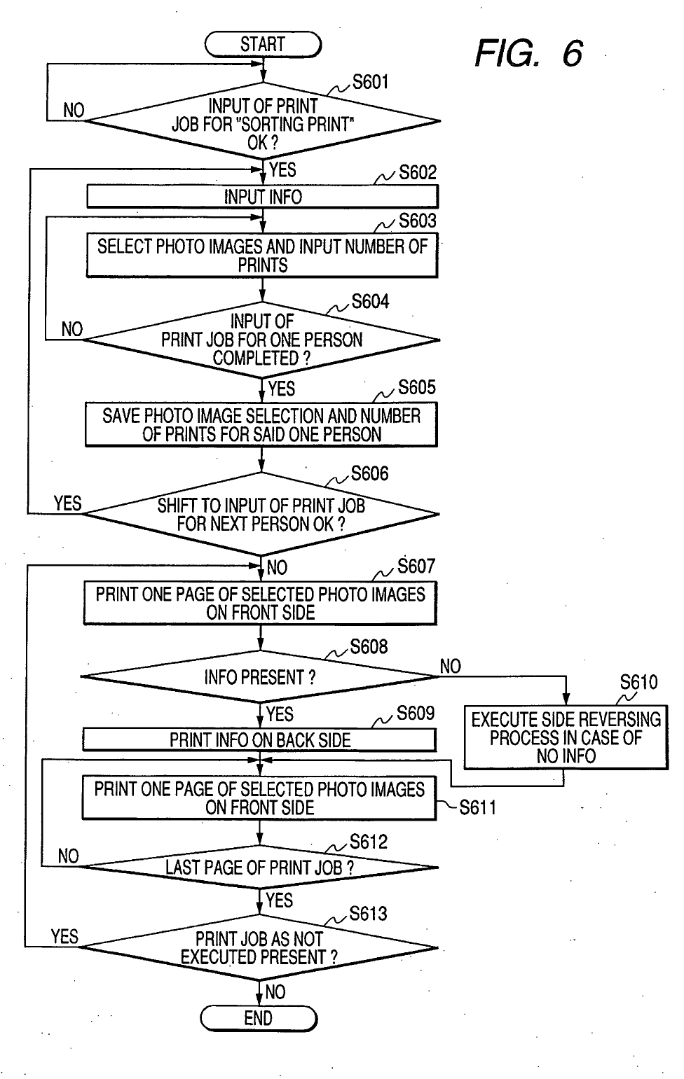

FIG. 6 is a flowchart showing the control operation in the fifth embodiment of the invention.

A construction in the fifth embodiment is similar to that of the recording apparatus 100 shown in FIG. 1.

The fifth embodiment relates to an example in which the head page of each print job is set to the divider page of the print job and information showing the person of the recorded media is printed on the back side.

Since processes in S601 to S606 are substantially the same as those in S301 to S306 shown in FIG. 3, their explanation is omitted here.

If the processing routine is not shifted to the print job input to be distributed to the next person in S606 but the print job inputs to be distributed to all of the people have been completed, the selected photo image is printed by one page onto the front side of the recording medium (S607).

In order to set the head page of the print job to the divider page of the print job, the process for setting such a page to the divider page of the print job is executed. The presence or absence of the information of indicative person inputted in S602 is discriminated (S608). If the information exists, the recording medium on the front side of which the selected photo image has been printed is reversed to the back side by the medium side reversing means 18 and the information is printed on the back side (S609). If the information does not exist, the back-side process (the medium is reversed and discharged in the back-side-up state; the divider mark is printed onto the back side; the print job serial number is printed onto the back side; or the like) in the case of the absence of the information is executed (S610).

Subsequently, in order to print the second and subsequent pages of the print job, the selected photo image is printed by one page onto the front side of the recording medium (S611). Whether or not the page printed in S611 is the last page of the print job is discriminated (S612). If the printed page is not the last page of the print job, the recording medium on the front side of which the selected photo image has been printed is discharged. The processing routine is returned to S611 and the selected photo image of the next page is printed.

If the printed page is the last page of the print job, the presence or absence of the print job which is not executed yet is discriminated (S613). If the print job which is not executed yet is found, the processing routine is returned to S607 and the selected photo image is printed by one page onto the front side of the recording medium. If the print job which is not executed yet is not found in S613 (in other words, if all of the print jobs to be distributed to all of the people have been completed), the processing routine is finished.

### Sixth Embodiment

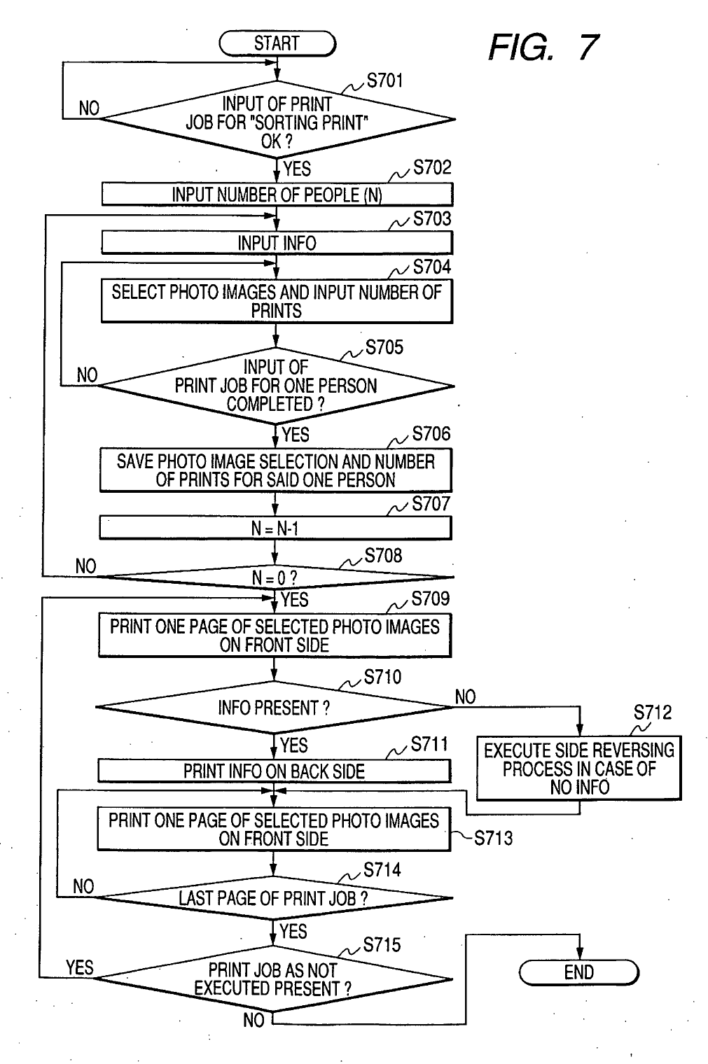

FIG. 7 is a flowchart showing the control operation in the sixth embodiment of the invention.

A construction in the sixth embodiment is similar to that of the recording apparatus 100 shown in FIG. 1.

The sixth embodiment relates to an example in which in the case where the sorting number for sorting the recorded media is preliminarily inputted prior to inputting the print job, the head page of each print job is set to the divider page of the print jobs and the information showing the person to be distributed is printed onto the back side.

Since processes in S701 to S708 are substantially the same as those in S401 to S408 shown in FIG. 4 and processes in S709 to S715 are substantially the same as those in S607 to S613 shown in FIG. 6, their explanation is omitted here.

According to the embodiment, in a recording apparatus having only one paper discharge port, the divider page which does not exist in the inherent print job is not inserted but the minimum number of recording media necessary for the print job are used and the recorded media according to a plurality of print jobs can be sorted. Therefore, it is possible to prevent the recording medium from being wastefully used.

According to the invention, the following effects are obtained: that is, one scene of an entertainment or an event such as group tour, field day, or the like is photographed by the digital camera, the image data of the photographed images is stored into the memory card, the image data is read out of the memory card, the photo images are printed, and when the additional copies of the photograph are made and distributed to many participants in the entertainment or the event, a burden of the operation to sort the photographs to be distributed to each person can be lightened without wastefully consuming the time.

This application claims priority from Japanese Patent Application No. 2005-155040 filed on May 27, 2005, which is hereby incorporated by reference herein.

What is claimed is:

1. A recording apparatus comprising:
storing means adapted to store image data;
operation means adapted to select image(s) stored in said storing means and input the number of prints of said selected image on a job unit basis;
recording means adapted to record the image onto a recording medium on said job unit basis; and
reversing means adapted to reverse the recording medium on which a predetermined page of each job has been recorded as a divider of each job when the image is continuously recorded on the job unit basis by said recording means after completion of the inputting operation by said operation means.

2. An apparatus according to claim 1, wherein identification information of each job unit is inputted by said operation means, and said recording means records said identification information onto a back side of the predetermined page of the recording medium reversed by said reversing means.

3. An apparatus according to claim 1, wherein a value corresponding to the number of people to be distributed the recorded media is inputted by said operation means prior to selecting the image and inputting the number of prints, and
said apparatus further has inputting operation control means adapted to control so that the operation for selecting the image and inputting the number of prints by said operation means is repeated the number of times corresponding to said value.

4. An apparatus according to claim 2, wherein
a value corresponding to the number of people is inputted by said operation means prior to selecting the image and inputting the number of prints, and
said apparatus further has inputting operation control means adapted to control so that the operation for selecting the image and inputting the number of prints by said operation means is repeated the number of times corresponding to said value.

5. An apparatus according to claim 2, wherein when the identification information is not inputted, said reversing means reverses a last page of the job unit and said recording means records a divider mark or a job number onto the back side of the last page.

6. An apparatus according to claim 2, wherein said predetermined page is a head page or a last page of each job.

7. An apparatus according to claim 1, wherein when a mode to record the image onto the recording medium on the job unit basis is selected by said operation means, said reversing means is validated.

8. A control method in a recording apparatus for recording image data stored in a storing unit onto a recording medium, comprising:
an input operating step of selecting image(s) stored in said storing unit and inputting the number of prints of said selected image on a job unit basis;
a recording step of recording the image onto the recording medium on said job unit basis; and
a reversing step of reversing the recording medium on which a predetermined page of each job has been recorded as a divider of each job when the image is continuously recorded on the job unit basis in said recording step after completion of the inputting operation by said operating step.

9. A method according to claim 8, wherein when identification information of each job unit is inputted in said input operating step, in said recording step, said identification information is recorded onto a back side of the predetermined page of the recording medium reversed by said reversing step.

10. A method according to claim 8 wherein a value corresponding to the number of people to be distributed the recorded media is inputted in said input operating step prior to selecting the image and inputting the number of prints, and said method further has an inputting operation control step of controlling so that the operation for selecting the image and inputting the number of prints by said input operating step is repeated the number of times corresponding to said value.

11. A method according to claim 9 wherein a value corresponding to the number of people to be distributed the recorded media is inputted in said input operating step prior to selecting the image and inputting the number of prints, and said method further has an inputting operation control step of controlling so that the operation for selecting the image and inputting the number of prints by said input operating step is repeated the number of times corresponding to said value.
